(19) United States
(12) Patent Application Publication
(10) Pub. No.: US 2004/0148427 A1
(43) Pub. Date: Jul. 29, 2004

(54) Method and apparatus for PPP link handoff

(76) Inventors: Madjid F. Nakhjiri, Palatine, IL (US); Shreesha Ramanna, Vernon Hills, IL (US); Ajoy K. Singh, Round Lake, IL (US)

Correspondence Address: MOTOROLA, INC., 1303 EAST ALGONQUIN ROAD, IL01/3RD, SCHAUMBURG, IL, 60196

(21) Appl. No.: 10/720,708

(22) Filed: Nov. 24, 2003

Related U.S. Application Data
(60) Provisional application No. 60/429,628, filed on Nov. 27, 2002.

(51) Int. Cl. G06F 15/16

(52) U.S. Cl. 709/237

(57) ABSTRACT

To address the need for an apparatus and method of PPP link handoff that reduces setup time and air interface bandwidth requirements, an approach to PPP context transfer is disclosed. This approach can cut the number of PPP establishment messages by 50 to 100% and can save a significant amount of time in PPP state machine transitions, due to the multiphase nature of PPP. Generally, the old AR (306) transfers most of its information about its PPP link with a mobile (330) to the new AR (305). After the transfer of the PPP variables is complete, the new AR is able to omit negotiation of many already known PPP parameters from the PPP re-establishment procedure with the mobile. The old AR starts transferring the mobile's PPP state to the new AR based either on an internal trigger, a request from the new AR, or a request from the mobile.

### REFERENCE(S) TO RELATED APPLICATION(S)

The present application claims priority from provisional application, Serial No. 60/429,628, entitled “METHOD AND APPARATUS FOR PPP LINK HANDOFF,” filed Nov. 27, 2002, which is commonly owned and incorporated herein by reference in its entirety.

### FIELD OF THE INVENTION

The present invention relates generally to communication systems and, in particular, to point-to-point protocol (PPP) link handoff.

### BACKGROUND OF THE INVENTION

Most of wireless access networks providing data service to mobile users rely on Point -to-Point protocol (PPP) between a mobile user and a network access node. Specifically, when a mobile terminal needs to gain access to a CDMA2000 IP data network, it has to establish a PPP link with the packet data serving node (PDSN) (a.k.a. an access router (AR) or access gateway). PPP provides a means of negotiating link parameters, layer 2 framing, network layer mechanisms, and in some cases authentication. It also provides a means of negotiating the layer 3 mechanisms to be used in mobile to network communications.

The establishment of a PPP link between a network access point (such as a PDSN) and a user involves a series of negotiations, so that both peers can agree on a set of link, identification, and network parameters that are acceptable to both parties. Hence, it is said that PPP link establishment involves “PPP negotiations” that are comprised of 3 phases:

1. Link establishment phase, called LCP (link control protocol) negotiations, which includes negotiating layer 2 link parameters, such as maximum frame size. Once LCP negotiation is complete, the PPP state machine moves to LCP UP state and starts the authentication phase.

2. Authentication phase includes negotiation of the type of authentication accepted by the server. In some of today's networks this phase is bypassed or combined with LCP phase, for instance Mobile IP users might rely on AAA or other Mobile IP authentication mechanisms. While the non-Mobile IP based users need to rely on PPP for authentication related message exchanges. Once the authentication negotiations are complete, the PPP state machine moves to authentication UP and starts the NCP phase.

3. Network protocol negotiation phase called network control protocol (NCP). During this phase, network layer parameters, such as IP address and type of supported IP header compression are communicated.

After the negotiation within each phase is complete, the PPP state machine transits to the next phase and state. All parameters during each phase must have been negotiated successfully, in order for the PPP state machine to move to the next state.

When a mobile user hands off to a new base station and a new PDSN, a new PPP link must be established between the mobile user and the new PDSN. Currently, this requires PPP negotiations between the mobile user and the new PDSN as illustrated in message flows 100 and 200, FIGS. 1 and 2, respectively. FIG. 1 is a message flow diagram of CDMA2000 messaging performed during an inter-PDSN handoff. The full PPP negotiation messaging of FIG. 1 is expanded in FIG. 2. Thus, FIG. 2 illustrates the relevant messaging performed in establishing the new PPP link. During the CDMA2000 PPP negotiation of message flow 200, the following options are negotiated or transmitted:

1. ASYNC_MAP (This option identifies the character set, which needs to be escaped during framing.)

2. PROTOCOL_FIELD_COMPRESSION (PPP header compression depending on the value of the header)

3. ADDRESS FIELD COMPRESSION (Addr and ctrl field from HDLC)

4. MRU (max receive Unit=max size of PPP information field)

5. Magic number

6. Van Jacobson Header Compression

7. AUTH_TYPE (to negotiation authentication protocol, such as CHAP) and Challenge during Authentication

8. PDSN IP Address and IP Address of the mobile

As can be clearly seen in FIG. 2, PPP negotiations involve several round trip times, database lookups, and processing. Moreover, each of these PPP messages has to be scheduled on an RF channel for delivery. At least two full-rate RLP frames on a Fundamental channel (FCH) are required to deliver each PPP message to its peer. Considering a 20 byte RLP frame scheduled at 20ms intervals on a FCH and an approximate value of 0.5 secs for scheduling delays (20 ms * 2 frames * 13 messages=520 ms) excluding the propagation and latencies within the network elements, the entire PPP negotiations in a CDMA2000 network typically require 2-2.5 seconds. Furthermore, this latency would increase to even higher values when retransmissions due to adverse radio link conditions or failed negotiations are needed.

While the PPP establishment's high setup times might be accepted during an initial data application startup, during a handover they can lead to unacceptable interruptions or even session failure (depending on the application settings). These times will not be acceptable for a voice application, such as voice over IP when implemented over CDMA2000. Moreover, the bandwidth that must be allocated to PPP message exchange is costly, reducing overall system capacity. Therefore, a need exists for an apparatus and method of PPP link handoff that reduces setup time and the air interface bandwidth requirements.

### BRIEF DESCRIPTION OF THE DRAWINGS

FIG. 1 is a message flow diagram of messaging performed during a CDMA2000 inter-PDSN handover.

FIG. 2 is a message flow diagram of messaging performed during a CDMA2000 PPP link establishment.

FIG. 3 is a block diagram depiction of a communication system in accordance with an embodiment of the present invention.

FIG. 4 is a message flow diagram of messaging performed during an inter-PDSN handover in accordance with an embodiment of the present invention.

FIG. 5 is a logic flow diagram of steps performed to facilitate an inter-PDSN handover in accordance with an embodiment of the present invention.

### DETAILED DESCRIPTION OF EMBODIMENTS

To address the need for an apparatus and method of PPP link handoff that reduces setup time and air interface bandwidth requirements, an approach to PPP context transfer is disclosed. This approach can cut the number of PPP establishment messages by 50 to 100% and can save a significant amount of time in PPP state machine transitions, due to the multiphase nature of PPP. Generally, the old AR transfers most of its information about its PPP link with a mobile to the new AR. After the transfer of the PPP variables is complete, the new AR is able to omit negotiation of many already known PPP parameters from the PPP re-establishment procedure with the mobile. The old AR starts transferring the mobile's PPP state to the new AR based either on an internal trigger, a request from the new AR, or a request from the mobile.

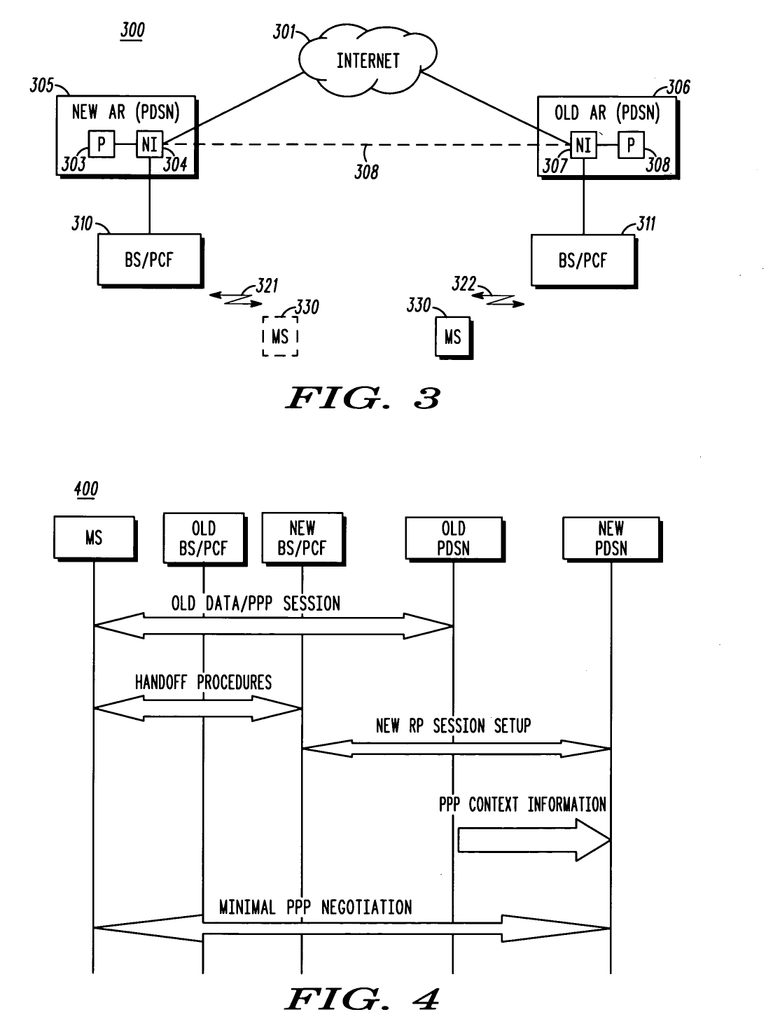

The disclosed embodiments can be more fully understood with reference to FIGS. 3-5. FIG. 3 is a block diagram depiction of a communication system 300 in accordance with an embodiment of the present invention. Communication system 300 is a well-known Code Division Multiple Access (CDMA) system, specifically a CDMA 2000 system, which is based on the Telecommunications Industry Association/Electronic Industries Association (TIA/EIA) standard IS-2000, suitably modified to implement the present invention. (The TIA/EIA can be contacted at 2001 Pennsylvania Ave. NW, Washington, D.C. 20006). In alternate embodiments, communication system 300 may utilize other cellular communication system protocols such as, but not limited to, the Global System for Mobile Communications (GSM) protocol, General Packet Radio Service (GPRS), IS-95, or Universal Mobile Telephone Service (UMTS).

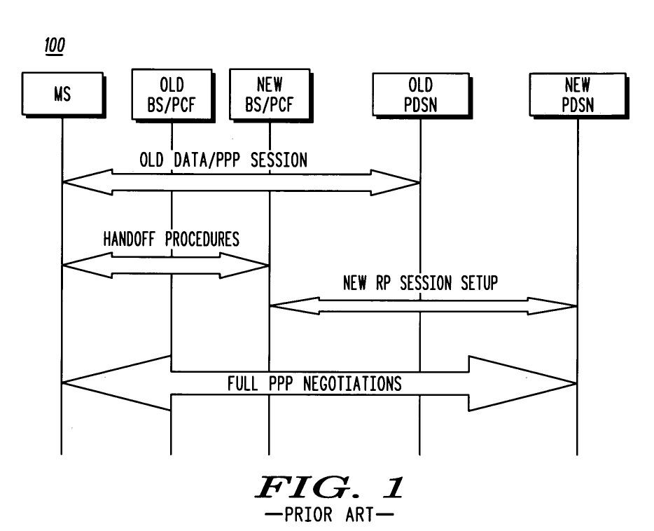

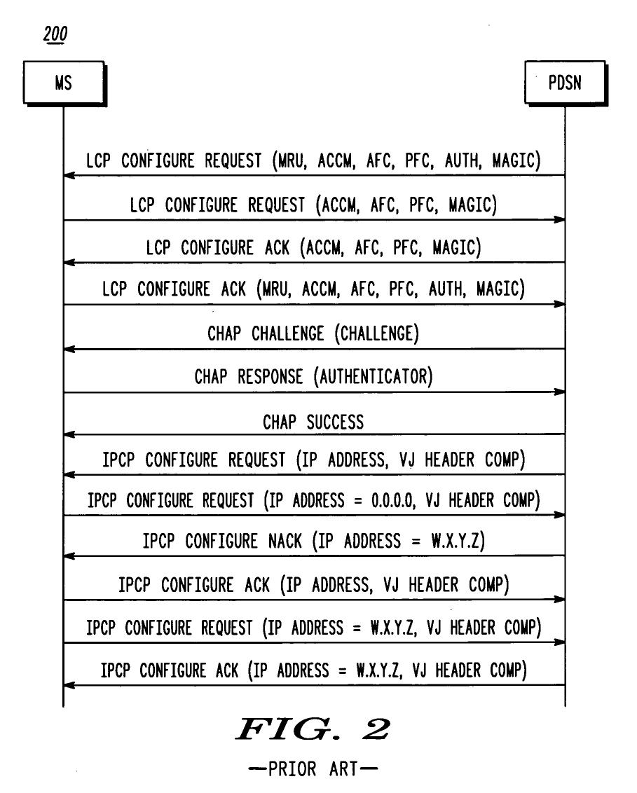

The first embodiment of the present invention includes a radio access network (RAN) and remote units, such as mobile node (MN) or mobile station (MS) 330 and 102. Those skilled in the art will recognize that FIG. 1 does not depict all of the network equipment necessary for system 300 to operate but only those logical entities particularly relevant to the description of embodiments of the present invention. For example, the RAN comprises well-known entities such as base stations and packet control functions (BS/PCFs 310 and 311) and packet data serving nodes (PDSNs 305 and 306), which interface with internet protocol (IP) network 301.

PDSNs 305 and 306 comprise network interfaces 304 and 307 and processors 303 and 308, both respectively. Those skilled in the art are aware of the many ways each of these entities can be implemented and/or purchased from wireless communications companies such as “MOTOROLA.” Network interfaces, for example, typically comprise components such as communications microprocessors, memory, and/or logic circuitry designed to implement algorithms that have been expressed as computer instructions and/or in circuitry. Likewise, processors typically comprise microprocessors, various memory devices, and/or logic circuitry designed to implement algorithms that have been expressed as computer instructions and/or in circuitry. Given an algorithm or a logic flow, those skilled in the art are aware of the many design and development techniques available to implement a PDSN that performs the given logic.

In system 300, old BS/PCF 311 communicates with MS 330 via CDMA2000 air interface resource 322, while new BS/PCF 310 communicates with MS 330 via CDMA2000 air interface resource 321. Although not shown in FIG. 3, RAN BS/PCFs also interface with devices such as mobile switching centers/virtual location registers (MSCNLR), home location registers (HLR), etc.

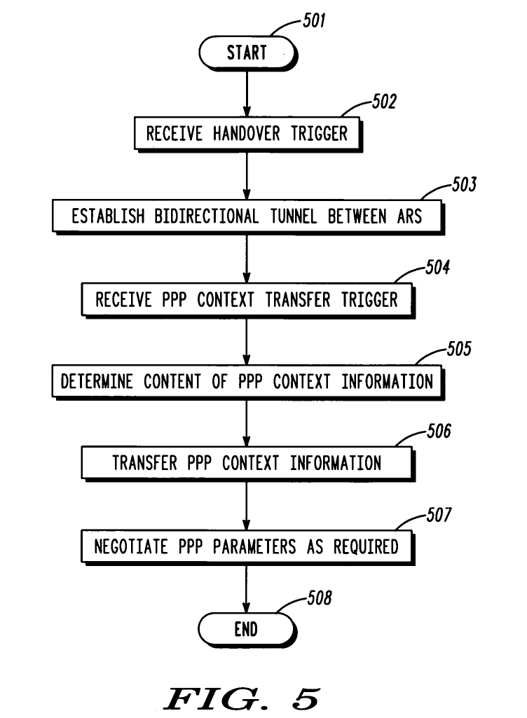

In a first embodiment of the present invention, a known CDMA2000 RAN is adapted using known telecommunications design and development techniques to implement the RAN aspect of the present invention. The result is a RAN, which performs the method described with respect to FIG. 5. Those skilled in the art will recognize that the RAN aspect of the present invention may be implemented in and across various physical components of system 300's RAN.

Operation of a first embodiment, in accordance with the present invention, occurs substantially as follows. FIG. 4 is a message flow diagram of messaging performed during an inter-PDSN handover in accordance with various embodiments of the present invention. Message flow 400, as compared to prior art message flow 100, shows the transfer of PPP context information from the old PDSN to the new PDSN. By performing this context transfer, PPP negotiations between the MS and the new PDSN can be minimized or even eliminated as is described in detail below.

Processor 308 of source AR 306 (i.e., the old PDSN) communicates with remote unit 330 (or MS 330) via a PPP communication link. Associated with this PPP link is PPP context information, which includes various negotiated PPP parameters. Processor 308 of source AR 306 determines that a PPP link handoff from source AR 308 to target AR 305 should occur based on a variety of triggers and then conveys the PPP context information to target AR 305.

Processor 303 receives the PPP context information via network interface 304 from source AR 306. Via network interface 304, processor 303 then establishes a PPP link with remote unit 330 using the PPP context information received. If necessary, processor 303 negotiates with remote unit 330 via network interface 304 PPP parameters not received from source AR 306.

The following parameters are the most commonly negotiated during a PPP setup:

1—SYNC_MAP

2—PROTOCOL_FIELD_COMPRESSION

3—ADDRESS FIELD COMPRESSION

4—MRU

5—Magic number

6—Van Jacobson Header Compression

7—AUTH_TYPE

8—new AR IP Address

9—MIP Flag: set for mobile IP users, cleared for simple IP user

The MIP Flag parameter is included because the user IP address is not part of PPP negotiation when mobile IP is used by the mobile node. In the simple IP case, the user arguably does not perform any Mobile IP handovers. However, some operator networks perform other types of handovers even for simple IP users. The application and signaling of PPP context transfer for such users may need specific optimization. For mobile IP users, on the other hand, many systems suggest that the user send a 0000 address as part of a registration request and receive a home address as part of a registration reply. Such signaling needs not be included as part of PPP context transfer. So from now on, we will only include the new AR IP address as part of IPCP negotiations and add an MIP Flag parameter as guidance for the new AR.

Parameters 1-4 do not change during a typical subnet handover, and hence need not be renegotiated after a handover. Also, implementation of magic number changes is a legacy issue of limited security value. The magic number is openly sent and can easily be sniffed. Hence, from a security standpoint it is only slightly stronger than a sequence number. Since this embodiment aims to eliminate the need for complete PPP tear down and re-establishment, there is no need for creation of a new random magic number.

Thus, in a first context transfer scenario (referred to as the “generic context transfer scenario”) the first 5 parameters are conveyed from old AR 306 to new AR 305 as soon as the either AR receives an indication that mobile 330 needs to handoff to a new AR. In this scenario, only the following parameters will remain to be negotiated after the completion of PPP context transfer:

1—Van Jacobson Header Compression

2—AUTH_TYPE, Challenge (during authentication protocol)

3—new AR IP address

Depending on the PPP implementation and system design, some of the above parameters may stay unchanged or may be transmitted through other means. Hence, as explained in the following, we can diverge from the generic scenario to a few more optimized scenarios, which lead to either complete elimination or greatly simplified and expedited PPP re-negotiations.

A second context transfer scenario (referred to as the “complete context transfer scenario”) is the most extreme case, completely eliminating PPP re-negotiations. All the necessary information for the PPP state machine can be transferred from old AR 306 to new AR 305. Hence, the PPP state machine at new AR 305 can achieve its steady state without the need for any negotiation messaging after mobile 330 moves to new AR 305. This complete context transfer scenario may occur when, for example, the following conditions are met:

1. New AR also supports the same header compression method that the old AR and mobile were using prior to handover and the old AR is aware of this.

2. PPP based authentication phase can be bypassed at the new site. If the user is relying on Mobile IP and AAA mechanisms and if the old and new AR are aware of the type of mobile stack, the authentication offered by the second phase of PPP can be bypassed. Note: Simple IP users, who may still rely on PPP authentication, cannot bypass this phase.

3. No IPCP negotiation is necessary, e.g. new AR IP address can be communicated through non-PPP means (such as agent advertisements) or the new AR IP address is know by the old AR through candidate AR discovery procedures.

Once the PPP parameters and state information are transferred and in place, the PPP state machine at the new AR can simply move to the same state at which the old AR PPP state machine resided. This would save the time required for the PPP state machine to transition through all its initial states, would save the several seconds of handover time, and would eliminate the scheduling RF resources for PPP negotiations.

Thus, for the complete context transfer scenario, the following parameters are sent to new AR 305 in addition to parameters 1-5 mentioned in the generic case:

VJ header compression parameters (to save radio bandwidth)

AUTH_TYPE

MIP flag

In a third context transfer scenario (referred to as the “LCP and IPCP context transfer scenario”), the entire LCP and IPCP negotiations are eliminated through the transfer of the LCP and IPCP portion of the PPP context information, but the authentication phase of PPP is not bypassed. This context transfer scenario may occur, for example, when either:

1—The mobile relies on PPP authentication and the parameters from the old AR cannot be used by the new AR for security reasons or due to a different type of authentication at the new AR.

2—The mobile does not rely on PPP authentication, but the information about the preferred authentication type cannot be conveyed or used by the new AR.

In this transfer scenario, PPP authentication messaging needs to happen between mobile 330 and new AR 305. However, some suggestions to ease the authentication process (such as supported authentication types by mobile) can be transferred from old AR 306 to new AR 305, if desired. Note that PPP negotiation cannot be completely eliminated in this case, but PPP context transfer still achieves the elimination of the LCP and IPCP phases. Also note that, although the IPCP parameters are in place, the PPP state machine cannot pass beyond LCP Up phase, since authentication message must be completed before the state machine can advance to IPCP setup.

In a fourth context transfer scenario (referred to as the “LCP and authentication context transfer scenario”), both LCP and authentication phase can be eliminated, but the NCP (IPCP for IP networks) phase negotiations still need to be performed for PPP link establishment. This context transfer scenario may occur, for example, when either:

1—Header compression scheme supported at the new AR is unknown or known to be different from that at oldAR.

2—The new AR IP address is not known and must be communicated directly to the mobile user during PPP negotiations.

In the first embodiment, Time Efficient Context Transfer (TEXT) is used for PPP context transfer. Traffic to and from mobile 330 can flow via old AR 306 through bidirectional tunnel 308, bidirectional edge tunnel (BET) between old AR 306 and new AR 305, while PPP context information is being transferred from old AR 306 to new AR 305. Prior to the establishment of a PPP link between mobile 330 and new AR 305, mobile 330 relies on its PPP link with old AR 306, while taking advantage of a secure air link (physical and radio link protocol) with new AR 305. This way mobile 330 does not have to establish a PPP link with new AR 305 in order to receive its traffic through BET.

However, before mobile 330 begins a messaging exchange with new AR 305, in order to acquire its new Care of Address (CoA) address, the PPP link must be established between mobile 330 and new AR 305 (Mobile IP sits on the top of PPP in the protocol stack). Thus, PPP context transfer needs to be completed, before mobile 330 begins new CoA acquisition, before the bi-directional tunnel is down. This differentiates PPP context transfer from other context transfers, which can be transferred even during CoA acquisition signaling.

Therefore, the following are potential triggers for PPP context transfer:

1—Start of BET establishment signaling: In most of cases (except when PPP timers are to be transferred) the PPP parameters are static throughout the lifetime of the bi-directional tunnel. In those cases, the same triggers used for BET establishment can be used to start PPP context transfer.

2—BET lifetime expiration: Expiration of the bi-directional tunnel can be used as the trigger for PPP context transfer. However, the old AR needs to request extension of tunnel lifetime from the new AR.

3-Physical link release indications: When the mobile data session goes dormant, i.e., when mobile traffic subsides. Due to the low bandwidth nature of the RF link, such indications are readily available in a timely manner at the RAN.

Examples include release of allocated Walsh codes in CDMA and release of allocated time slots in TDMA systems.

This type of indication needs to be communicated to the PDSN using some BS/PCF to PDSN signaling.

Once, the PPP context information is transferred to new AR 305, old AR 306 is responsible for the PPP termination (through new AR 305 to mobile 330 via tunnel 308) and new AR 305 needs to download and install mobile 330's PPP context, before mobile 330 starts new CoA acquisition procedures to assume new AR 305 as its default router.

FIG. 5 is a logic flow diagram of steps performed to facilitate an inter-PDSN handover in accordance with various embodiments of the present invention. FIG. 5 illustrates but one order in which these general steps may be performed. A person of ordinary skill in the art will recognize that these steps may be performed in a different order or even concurrently depending on the particular design or implementation goals of an implementation.

Logic flow 500 begins (501) when the old AR or new AR receives (502) a trigger (source trigger or target trigger, respectively) for handover and starts establishing (503) a bi-directional tunnel. PPP context transfer can happen along with tunnel establishment signaling, if needed. However, PPP context transfer is preferably performed at some later point, depending on the flow of data traffic. Generally, a trigger for PPP context transfer will be received (504), such as the expiration of the tunnel lifetime (assuming the tunnel lifetime. can be extended). One implication of source or target trigger is that either the old AR pushes the context transfer to the new AR or the new AR requests the old AR to transfer the PPP context information.

The content of the PPP context information to be transferred is determined (505). For example, the PPP context information may only include the types of PPP context information that are applicable to the new AR (as discussed above with respect to the various scenarios). To determine what information may be applicable to the new AR, the old AR may at some time request the new AR's capabilities and maintain a capability record for the new AR. The old AR then transfers (506) the PPP context information determined and may even indicate which types of context information are being transferred. Having received the PPP context information, the new AR negotiates (507) with the mobile, if necessary, to establish the new PPP link between the mobile and the new AR, and logic flow 500 ends (508).

It is desirable that the context transfer mechanism deliver the PPP context reliably to avoid the need for PPP re-negotiation by the mobile and the new AR. It is expected that even a few rounds of retransmissions over the wired link (between old AR and new AR) will be more efficient than PPP re-negotiation between the mobile and the new AR. Both the old and new AR should support reliable context transfer. Thus, the reliability required flag (R) needs to be set. In the case of a dynamic PPP context (such as with timer values) being transferred, the update flag (U) needs to be set as well to allow transmission of refreshed timer values.

Most of the PPP context data at each AR (not during AR handover) is static for the entire session. Hence, most of the transferred PPP context will not change with time or data traffic as long as the mobile doesn't perform another handover. This also means that in the case of transmission failures the PPP context can be simply retransmitted and updates would not be needed. The exception to this practice is when PPP timers are used. The use of these timers is explained below.

The PPP session has a limited lifetime. This lifetime is monitored using two parameters the PPP inactivity timer and the PPP session timer/Mobile IP registration lifetime. In the case of Mobile IP users, the PPP inactivity timer is ignored by the AR, and the Mobile IP registration lifetime is used instead of the PPP session timer. Thus, for mobile IP users, none of the PPP timers need to be maintained, and hence, the PPP context is completely static. However, for simple IP users, these timers are maintained, and the count value of these timers should be transferred as part of the PPP context information to the new AR. This is done, since, for retransmissions, the values of the timers need to be refreshed and hence updates are required.

As a general caveat, if the new AR is requiring PPP based authentication or header compression mechanisms different from those used by the old AR, the authentication and header compression context information will be irrelevant and should therefore not be transferred to the new AR.

The message flow for generic context transfer as well as context transfer header applies to PPP. Note however, that the PPP context transfer needs to happen reliably and hence the otherwise optional reliability mechanism for a generic context transfer protocol should be applied for PPP. Thus, the following values in the context header and payload need to be configured as follows:

R flag in CT header should be set to indicate that the message includes a feature (PPP) that requires reliability.

The feature profile type (FPT) for PPP would be called PPT, i.e., PPP profile type. This would be indicated in PPP data option (part of the context transfer payload).

R flag in PPP data option (part of the context transfer payload) should be set to indicate PPP reliability requirement.

U flag should be set in case PPP timer values are being transferred. In that case Feature Context data timestamp should be added as well.

Furthermore, 3 new flags are added to the PPP data option to indicate which PPP type parameter is being transferred.

L flag: If set, means an LCP parameter option is included.

A flag: set, means authentication parameter option included.

N flag: set, means network parameter option included.

The combination of flags also indicates the type of PPP context transfer scenario (as explained earlier) as follows:

| L A N | Scenario |
|---|---|
| 0 0 0 | Reserved for Generic scenario |
| 1 0 1 | LCP and IPCP parameter transfer |
| 1 1 0 | LCP and authentication transfer |
| 1 1 1 | Complete PPP parameter transfer |

PPP context is deemed sensitive for security purposes, hence, PPP context transfer must happen in a secure manner based on security associations between the new AR and old AR. Any signaling between the mobile and the new AR (such as a context transfer start request) should be protected through known radio interface security mechanisms.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention. In addition, those of ordinary skill in the art will appreciate that the elements in the drawings are illustrated for simplicity and clarity, and have not necessarily been drawn to scale. For example, the dimensions of some of the elements in the drawings may be exaggerated relative to other elements to help improve an understanding of the various embodiments of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The term program, as used herein, is defined as a sequence of instructions designed for execution on a computer system. A program, or computer program, may include a subroutine, a function, a procedure, an object method, an object implementation, an executable application, an applet, a servlet, a source code, an object. code, a shared library/dynamic load library and/or other sequence of instructions designed for execution on a computer system.

What is claimed is:

1. A method for point-to-point protocol (PPP) link handoff comprising:
communicating, by a source access router (AR), with a remote unit via a PPP communication link, wherein PPP context information is associated with the PPP communication link;
determining that a PPP link handoff from the source AR to a target AR should occur; and
conveying the PPP context information to the target AR.

2. The method of claim 1, further comprising conveying traffic information via a tunnel between the source AR and the target AR.

3. The method of claim 2, wherein conveying the PPP context information and conveying the traffic information occur concurrently.

4. The method of claim 2, further comprising:
determining when the tunnel between the source AR and the target AR will expire based on a tunnel lifetime; and
extending the lifetime of the tunnel in order to convey the PPP context information.

5. The method of claim 1, wherein conveying the PPP context information comprises conveying the PPP context information when a period of low remote unit data activity begins.

6. The method of claim 1, wherein PPP context information comprises timer information used for PPP operation.

7. The method of claim 1, wherein conveying the PPP context information comprises conveying only types of PPP context information that are applicable to the target AR.

8. The method of claim 7, further comprising requesting, by the source AR, target AR capabilities from the target AR.

9. The method of claim 7, further comprising sending, by the source AR, an indication of which types of context information are being conveyed.

10. The method of claim 7, further comprising maintaining, by the source AR, a record of the target AR's capabilities.

11. The method of claim 7, wherein conveying the PPP context information comprises sending parameters selected from the group consisting of SYNC_MAP, PROTOCOL_FIELD_COMPRESSION, ADDRESS FIELD COMPRESSION, MRU, Magic number, Van Jacobson Header Compression, AUTH_TYPE, the target AR Internet Protocol (IP) Address, Mobile IP (MIP) Flag, PPP in-activity timer, and PPP session timer.

12. The method of claim 7, wherein conveying the PPP context information comprises sending only link control parameters and network control parameters.

13. The method of claim 7, wherein conveying the PPP context information comprises sending only link control parameters and authentication parameters.

14. The method of claim 13, wherein a header compression scheme supported by the target AR is not known by the source AR to match a header compression scheme used by the source AR for the PPP communication link.

15. The method of claim 7, wherein conveying the PPP context information comprises sending link control parameters, authentication parameters, and network control parameters.

16. The method of claim 15, wherein a header compression scheme supported by the target AR is known by the source AR to match a header compression scheme used by the source AR for the PPP communication link.

17. A method for point-to-point protocol (PPP) link handoff comprising:
receiving, by a target access router (AR), PPP context information from a source AR; and
establishing, by the target AR, a PPP link between the target AR and a remote unit using the PPP context information.

18. The method of claim 17, further comprising negotiating, by the target AR with the remote unit, PPP parameters not received by the target AR from the source AR.

19. The method of claim 18, further comprising:
determining that at least a portion of the PPP context information is not applicable to the target AR; and
negotiating, by the target AR with the remote unit, PPP parameters corresponding to the PPP context information determined to not be applicable to the target AR.

20. The method of claim 17, further comprising sending, by the target AR, capabilities of the target AR to the source AR.

21. The method of claim 17, wherein the beginning of a period of low remote unit data activity triggers establishing the PPP link.

22. The method of claim 17, further comprising receiving traffic information via a tunnel between the source AR and the target AR.

23. The method of claim 22, further comprising determining when the tunnel will expire based on a tunnel lifetime, wherein establishing the PPP link comprises establishing the PPP link based on when the tunnel will expire.

24. The method of claim 22, further comprising determining when the tunnel will expire based on a tunnel lifetime and extending the lifetime of the tunnel in order to establish the PPP link before the tunnel expires.

25. The method of claim 22, further comprising:
establishing a network layer link between the target AR and the remote unit using the PPP link.

26. The method of claim 25, further comprising:
tearing down the tunnel between the source AR and target AR after establishing the network layer link.

27. A source access router (AR) comprising:
a network interface; and
a processor, communicatively coupled to the network interface, adapted to communicate with a remote unit via a PPP communication link via the network interface, wherein PPP context information is associated with the PPP communication link, adapted to determine that a PPP link handoff from the source AR to a target AR should occur, and adapted to convey the PPP context information to a target AR via the network interface.

28. The source AR of claim 27, the processor is further adapted to convey traffic information via a tunnel between the AR and the target AR.

29. A target access router (AR) comprising:
a network interface; and
a processor, communicatively coupled to the network interface, adapted to receive, via the network interface, PPP context information from a source AR and adapted to establish, via the network interface, a PPP link between the target AR and a remote unit using the PPP context information.

30. The target AR of claim 29, the processor is further adapted to negotiate, With the remote unit via the network interface, PPP parameters not received by the target AR from the source AR.

31. The target AR of claim 29, wherein the target AR comprises a packet data serving node (PDSN).

32. The target AR of claim 29, wherein the target AR comprises a GPRS gateway support node (GGSN).
